(19) United States
(12) Patent Application Publication
(10) Pub. No.: US 2026/0360113 A1
(43) Pub. Date: Nov. 12, 2026

(54) Synthetic Anomaly Generation for Machine Learning Applications

(71) Applicant: Axon Enterprise Inc., Scottsdale, AZ (US)

(72) Inventors: Leo Dirac, Seattle, WA (US); Brandon Wada, Seattle, WA (US); Roxanne Oglesby, Seattle, WA (US)

(21) Appl. No.: 19/203,024

(22) Filed: May 8, 2025

(51) Int. Cl. G06V 10/764; G06V 10/778

(52) U.S. Cl. CPC G06V 10/764; G06V 10/7788

(57) ABSTRACT

An image classification system may be trained using images representing anomalies of a situation, where the anomalies have been generated artificially. A set of images representing a default or common state may be generated using cameras or other image capture devices, but anomalies may be artificially generated by modifying default state images to represent the anomalies. A list of anomalies may be generated by identifying objects in a default state image and suggesting alternative states or positions for the objects. For each of the anomalous states, representative images may be artificially created. In some cases, the images may be presented to a human user to approve as an anomaly, or resubmitted for automatic image generating with updated query. When appropriate anomalous images have been identified, additional images may be automatically generated to have sufficient number of images for classification training.

### BACKGROUND

Machine learning systems offer the promise of very sophisticated classification and data analytics. Such systems are able to be “trained” to identify or classify objects within images, as well as to understand natural language and other use cases.

Machine learning systems often require a set of “training data” that are pre-classified objects that are used to train a neural net or other classifier. The training data is often developed by classifying an image or set of images representing the natural state of a situation, then capturing images of all anomalies.

### SUMMARY

An image classification system may be trained using images representing anomalies of a situation, where the anomalies have been generated artificially. A set of images representing a default or common state may be generated using cameras or other image capture devices, but anomalies may be artificially generated by modifying default state images to represent the anomalies. A list of anomalies may be generated by identifying objects in a default state image and suggesting alternative states or positions for the objects. For each of the anomalous states, representative images may be artificially created. In some cases, the images may be presented to a human user to approve as an anomaly, or resubmitted for automatic image generating with updated query. When appropriate anomalous images have been identified, additional images may be automatically generated to have sufficient number of images for classification training.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an example set of images used for training a classifier.

FIG. 2 is a diagram illustration of an example showing a schematic or functional representation of a network with various devices that may deploy an image classifier with automatically generated anomaly images.

FIG. 3 is a flowchart illustration of an embodiment showing a method for creating and deploying an image classification system with automatically generated anomaly images.

### DETAILED DESCRIPTION

### Image Classification Using Artificially Generated Anomalies

An image classification system may be trained using images of anomalies that are artificially generated. In many image analysis systems, a camera or other image capture device may monitor a situation that rarely changes. In such a case, the system may have large numbers of images that may represent a standard situation, but very few images, if any, that may represent an anomaly.

For example, a security camera may be trained in an interior hallway of a school that has a fire extinguisher mounted in a cabinet on the wall. The security camera may be able to generate many images of the fire extinguisher properly stowed. However, the security camera may not capture any images of the fire extinguisher being accessed or used. The security system may wish to identify when someone accesses the fire extinguisher and trigger an alarm for additional help for that location, for example.

In the example, an automated anomaly image generator may identify the different ways a fire extinguisher may be accessed, moved, deployed, or otherwise used in a way that may trigger an alarm. An anomaly image generator may determine a set of different ways the fire extinguisher may be accessed or used, then generate images representing such situations by modifying an image representing a standard or default state.

The anomaly image generator may generate descriptions of several different ways the fire extinguisher may be accessed or used. Such a description may include opening the fire extinguisher cabinet and removing the fire extinguisher. But other descriptions may include breaking the glass on the fire extinguisher cabinet with an object, a person's hands, or other means. Further, the descriptions may include a person holding the fire extinguisher by a handle, as if to put out a fire. But other descriptions may include holding the extinguisher in other ways, such as to use the extinguisher as a battering ram to break something. The list of anomalous ways a fire extinguisher may be used is enormous in this example.

The automated anomaly image generator may use a large language model (LLM) or other tool to assist in generating descriptions of the anomalous states. Some systems may include a human in the loop to suggest a list of possible anomalous states initially, and possibly a human may approve, reject, or further refine the suggestions from the LLM or other tool.

A series of images representing the anomalous situations may be generated once a series of descriptions of anomalous situations may be identified. The series of images may or may not be validated and approved by a human classifier, and in many cases, an automated anomaly image generator may generate many images for each identified situation. When many images of a specific situation may be generated, the automatic anomaly image generator may vary the image such that the image classification system may more accurately classify an anomaly once the classification system is trained.

The automated anomaly image generator may assist in generating images for a host of hypothetical anomalies for a given baseline image. In many cases, a given camera may monitor a situation where several different events may occur, and an image classifier may be trained to identify and classify each of the various events, along with a general purpose of an anomaly. For each of the various events being classified, some systems may generate sufficient images for each anomaly situation so that the specific event may be identified when and if the event occurs.

A text-to-image model may be used to generate images of various anomalies. Such artificial intelligence models may receive a text-based description of the anomaly and may modify a baseline image to show the anomaly. In the example above of the fire extinguisher, a text-based description may include instructions to identify the fire extinguisher cabinet and generate an image with the cabinet door open, with the cabinet door broken, or with the cabinet removed from the wall. Such descriptions may be used to show changes to the fire extinguisher cabinet, which may be anomalies in a security camera monitor. A text-to-image model may generate different versions of each of the anomalous situations described, and such images may be used to train a classifier. The classifier may run without human supervision and may trigger an alarm once one of the anomalous situations occur.

The automated anomaly image generator may be useful when images of an anomalous situation cannot be easily generated. In our fire extinguisher example, a broken or damaged fire extinguisher cabinet may not be desirable to recreate in a physical environment just for the purpose of generating images of a damaged or accessed fire extinguisher cabinet. By generating the anomalous images automatically and without creating actual images of damaged cabinets, a classifier may be far better trained and produce far more accurate classifications even when the anomalous situations have never occurred in the physical world.

### Improvements to Computing Architecture and Performance

The automated anomaly image generator and associated processes, procedures, applications, and systems represent an improvement to the performance and capability of otherwise generic computing devices.

The automated anomaly image generator and related systems discussed herein improve the efficiency and effectiveness of image classification systems by generating far more images of anomalies for classification training than may be available had the automated anomaly image generator was not used. An automated anomaly image generator may be capable of generating multiple images of an anomaly, which may be in the handful of images, but such systems may generate tens, thousands, or even millions of images of a specific anomaly. Such large numbers of anomaly images may not be capable of being generated using conventional human efforts. As such, the automated systems described herein dramatically improve the processing and effectiveness of classification systems far in excess of what could possibly be accomplished using non-automated, manual methods.

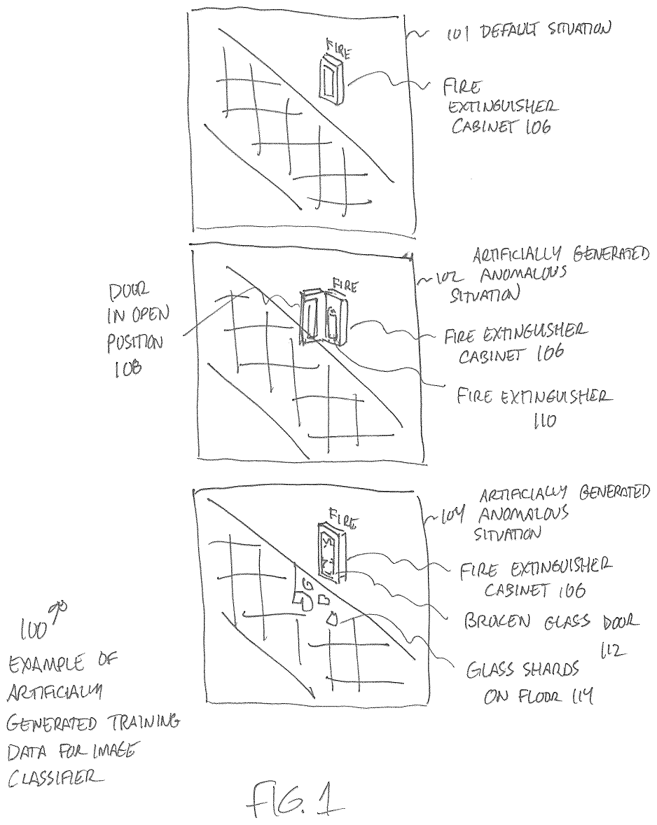

FIG. 1 is an example 100 of an artificially generated training images for an image classifier. A default situation 101 may be an image generated, in this example, by a security camera. Images 102 and 104 may represent two different artificially generated images of anomalous situations.

Image 101 may be a default situation showing a hallway with a fire extinguisher cabinet 106 in the normal, closed position. When setting up a security system, a user may install and mount a security camera that generates the image 101, and may also configure an image classifier to assist with identifying anomalies that may indicate problems or specific situations needing attention.

Image 102 may represent an artificially generated image showing a situation where the fire extinguisher cabinet 106 may be shown with a door in an open position 108 and where the fire extinguisher 110 may be shown in the cabinet 106.

Image 102 may be artificially generated as one instance of a training data set that may be used to train an image classifier. The image classifier may operate by continuously monitoring the feed from the security camera and may set an alarm or perform some other action when an anomaly is detected.

Image 104 may represent an artificially generated image showing a situation where the fire extinguisher cabinet 106 has a broken glass door 112. The artificially generated image may also show glass shards 114 on the floor and other evidence of damage.

Images 102 and 104 may be artificial manipulations, enhancements, or changes to a default situation 101. The images 102 and 104 may be generated by artificial intelligence models that may receive a verbal description of modifications to make to the default situation 101, such as to show the fire extinguisher cabinet 106 as open or broken.

The images representing anomalous situations may be generated automatically, using artificial intelligence-based text-to-image generation system. A set of text prompts may be generated that reflect the different ways a situation may unfold. In example 100, a baseline situation 100 may be changed by opening the fire extinguisher cabinet door, generating image 102. Another change may be to show the fire extinguisher cabinet door damaged, such as having the glass broken, as in image 104.

For image classifiers to operate properly, the classifier may be trained on a set of images representing a baseline situation and a set of images that may represent anomalies or other situations that may be tagged with an anomaly description. One way to generate images of an anomaly may be to stage the physical objects in the anomalous position. In example 100, for example, a user would stage the door being in an open position 108 and may stage damaging the glass door 112 and spreading broken glass 114. Such physical staging of the scene may be both cost prohibitive and time consuming. Further, there may be five, ten, hundreds, or even thousands of anomalous situations that might be possible in a given scene, making physical staging of each situation costly and time consuming.

An artificial intelligence text-to-image generation system may generate tens, thousands, or even more different images that may represent different anomalous scenarios. Further, each of the text descriptions used to generate the anomalous images may include a classification tag or may have a classification tag automatically generated. The classification tag may help a classification system correctly identify the specific anomaly that may be observed.

Conventional image classification systems may be trained on a default situation 101 without tagged or pre-classified anomalous images. Such systems may be able to detect deviations from the default situation 101, but may not be able to provide further information. In other words, such classifiers may set an alarm that something is different or deviated from the default situation 101, but a human may be left to look at the image to determine what went wrong.

With a set of tagged, artificially-generated images of anomalous situations, a classifier may provide much more meaningful analysis of a default situation 101. For example, image 102 may represent a situation where the fire extinguisher door 108 is open but the fire extinguisher 110 may still be present. This may generate, for example, a low level alarm for a maintenance worker or security worker to manually check the cabinet.

If, on the other hand, an anomalous image similar to image 102 may be generated that shows the cabinet door open 108 but the fire extinguisher 110 is not present, a higher level alarm may be raised. Such a situation may indicate that a person opened the cabinet 106 and removed the fire extinguisher 110. The alarm may be based on the assumption that a fire extinguisher 110 may have been used to address an immediate fire.

Such an example may illustrate why multiple anomalous situations may be generated, tagged, and used to artificially generate images representing various situations. The more detailed the descriptions of the anomalous situations and the more detailed the tagging, the more accurate results may be obtained from an image classifier with more accurate alarms or suggestions based on the specific anomalous situation.

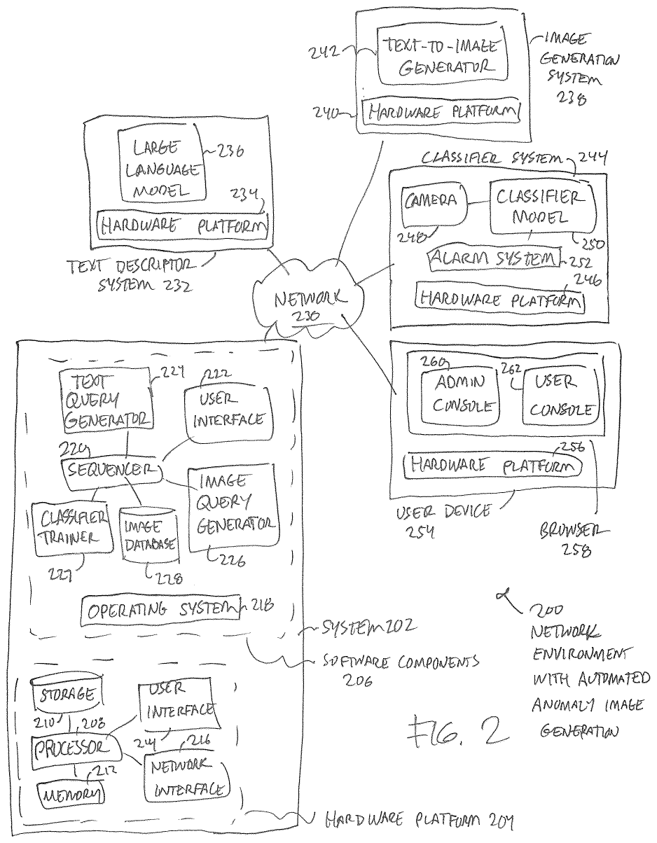

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a device 202 that may have a hardware platform 204 and various software components. The device 202 as illustrated represents a conventional computing device, although other embodiments may have different configurations, architectures, or components.

In many embodiments, the device 202 may be a server computer. In some embodiments, the device 202 may still also be a desktop computer, laptop computer, netbook computer, tablet or slate computer, wireless handset, cellular telephone, game console or any other type of computing device. In some embodiments, the device 202 may be implemented on a cluster of computing devices, which may be a group of physical or virtual machines.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable. In some embodiments, the nonvolatile storage 212 may be cloud based, network storage, or other storage that may be accessed over a network connection.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 on which various software components and services may operate.

A sequencer 220 may manage the flow of operations between several software components. A user interface 222 may allow a user to initiate a classifier, including generating training data, managing the training and testing of a classifier, as well as administering the classifier during operations.

Setting up and training a classifier may involve generating a set of text queries for a text-to-image generator, using a text query generator 224. The text query generator may use a large language model, human input, or other technique to generate a list of various anomalies that a classifier may identify. The list of text queries may identify objects within a baseline image, and the queries may also identify or could be used to identify specific tags that may be returned by a classifier when such an anomaly may be identified.

A set of text queries may identify the issues intended for a classifier to identify. In the example 100, the issues may include any access, movement, damage, use, or other changes to a fire extinguisher cabinet. Within the set of potential issues, some issues may be classified as urgent (such as the indication of use of the fire extinguisher) and non-urgent (such as the door being open but the fire extinguisher still present).

In another example, an industrial use of an image classifier may monitor an automated machining center. A camera may be positioned to check that a blank may be properly positioned in a vice, and that a cutting tool may be present and properly positioned. Potential issues may include that a blank may not be present, the blank may be an incorrect size, the blank may be misplaced in the vice, the vice may be properly positioned to accept and hold the blank, and similar error conditions.

Regarding the cutting tool, a text query generator 224 may generate several potential issues, including the wrong cutting tool may be present, the cutting tool may be broken or damaged, the cutting tool may have slipped in its holder, or similar error conditions.

An image query generator 226 may take the various conditions identified by the text query generator 224 and may generate queries that may be used by a text-to-image generator. An image query may take the form of identifying a baseline image, identifying specific items in the baseline image, and describing in words the changes to those items in the baseline image.

For example, an image query generator 226 may generate a query that identifies a blank that normally may be held in a vice, using the example above. The query may identify a modification to the baseline image where the blank may be rotated clockwise in the vice as well as a second modification where the blank may be rotated counter clockwise. Such detailed queries may be generated for each potential anomaly situation.

The detailed text-to-image queries may be sent to a text-to-image generator to create modified images for each query. The modified images may be presented to a user through the user interface 222, and the user may approve or deny the modified images. When the user may not be satisfied with the automatically generated images, the user may be given the opportunity to modify the image or query. The process may loop back with an updated image until the user may be satisfied with the image. In some cases, the user may return to an earlier step of identifying the anomaly description to modify the description prior to creating the image query.

Once an image may be approved by a user, some systems may generate many different images representing each individual anomaly. In some cases, a classifier may be trained using a single image or a small handful of images to successfully identify an anomaly. In other cases, a classifier may be trained using tens, hundreds, or even thousands or more images of an anomaly. Because the anomaly images may be automatically generated, larger numbers of anomalies may be easily generated, which may produce more accurate classification.

Each image may be tagged with a specific anomaly description. In some cases, a description, such as “blank not correctly placed in vice” may have many different images representing the condition. In this example, the same tag may be applied when the blank may be rotated clockwise as well as counter clockwise, as well as when the blank may be too high or too low in the vice, as well as many other conditions. Each of the conditions may be represented by one or more automatically generated images representing that specific condition.

The automatically generated images may be stored in an image database 228, which may be used by a classifier trainer 227 to create a classification algorithm. In many cases, an artificial neural network or other classifier may be used.

A sequencer 220 may have a validation step where a trained classifier may be tested against one or more anomaly test images to validate that the classifier operates properly. In some instances, the user interface 222 may display an anomaly test image and the results from the classifier. A user may manually validate that the classifier may be operating properly. If a classifier may not be as accurate as desired, the user may be able to redo some or all of the steps to generate queries, generate images, and retrain the classifier until the user may be satisfied with the results.

A network 230 may connect various devices illustrated.

A text descriptor system 232 may operate on a hardware platform 234 and may operate a large language model 236. The large language model 236 may be used to generate a list of written descriptions of anomalies that may occur. The anomalies may be any issue or abnormality that may be detected by a classifier. The quality of the classification may improve when a larger list of anomalies may be generated, as each anomaly may capture a specific mechanism that the anomaly might occur.

An image generation system 238 may operate on a hardware platform 240 and may have a text-to-image generator 242. The text-to-image generator 242 may receive a written description of an image or a written description of changes to an image, and the text-to-image generator 242 may produce an image corresponding with the description. The automatically generated images may be used, along with their tagged descriptions, to train an image classifier model.

A classifier system 244 may operate on a hardware platform 246 may include a camera 248 and classifier model 250. In some cases, the camera 248 and classifier model 250 may operate on two separate hardware platforms, but for the example, both are shown on a common platform.

The classifier model 250 may be a pre-trained model that may identify anomalies from images captured by the camera 248. Some systems may process individual still images, while other systems may process video images.

When an anomaly may be identified by a classifier model 250, an alarm system 252 may activate an alarm. An alarm may be any predefined action that may be specified, such as send a communication to a person or another device, cause an action to be stopped or another action to be initiated, or perform any other action. In many cases, an alarm system 252 may have a set of rules, heuristics, procedures, processes, or other programmed steps or sequence that may be performed when a specific alarm may be triggered.

In the above example of a system used to monitor a machining operation, an alarm for the misplacement of a blank in a vice or a broken cutting tool, for example, may trigger an alarm that may halt operation of the machine and summon a human operator to correct the situation. In another use case with the same example, an anomaly regarding any problem with the cutting tool could trigger the machining center to swap the tool with a new one. In still another use case, some anomalies may simply be identified and counted without alerting a human operator.

For each anomaly that may be identified for the classifier model 250, an alarm system 252 may have some defined action that may be taken.

A user device 254 may operate on a hardware platform 256 and may present an administrative console 260 and user console 262 within a browser 258. The user device 254 may be one example of a device through which a user may access a user interface 222 generated by the system 202.

An administrative console 260 may present a user interface through which a user may perform administrative tasks, such as initiating a new classifier, generating lists of potential anomalies, reviewing and correcting automatically generated images representing the anomalies, and launching and managing a classifier.

A user console 262 may present a user interface for the classifier model 250 and alarm system 252. The user console 262 may present status updates, alarm notifications, operational statistics, images identified as anomalies, and other information to a human operator.

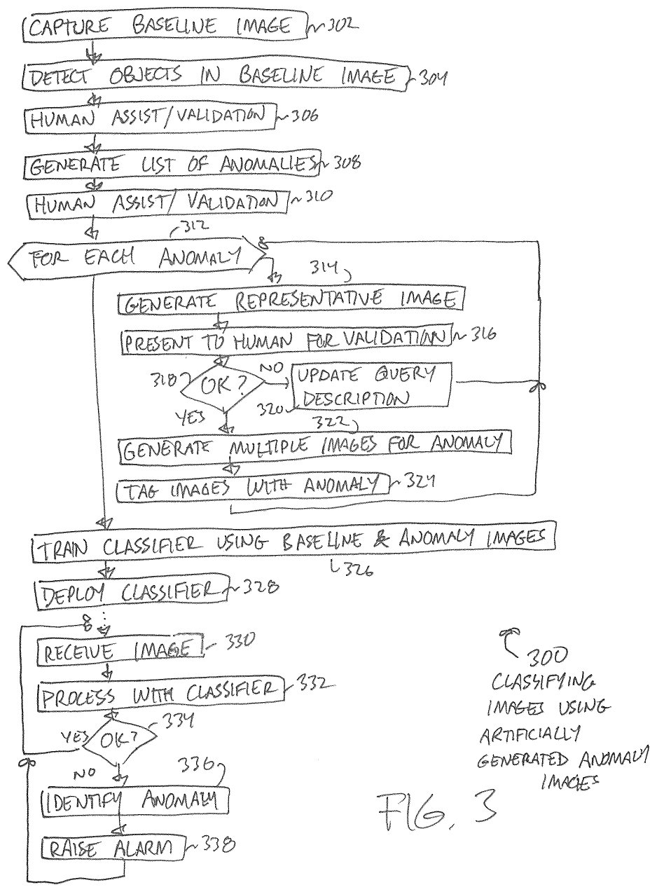

FIG. 3 is a flowchart illustration of an example 300 showing a method for classifying images using artificially generated anomaly images. The operations of example 300 illustrate one workflow of how a classification engine may be trained and deployed using artificially generated images depicting various anomalies.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Example 300 illustrates one workflow by which images representing various anomalies may be generated using text-to-image generators. Prior to generating images, a detailed list of potential anomalies may be identified and described. The descriptions may be used at least in part to artificially generate images depicting the anomalies. Once the images have been generated, the artificially generated images may be use to train an image classifier, which may be deployed.

A baseline image may be captured in block 302. In many cases, the baseline image may be an image depicting a standard condition of a scene, and various anomalies may be generated from the baseline image. In other cases, however, the baseline image may be a particular anomaly, and an artificially generated image may be used to depict a baseline image. In either case, a starting image may be captured.

Within a baseline image, various objects may be identified and tagged in block 304. The tagged or labeled objects in an image may be referenced by text-based descriptions of anomalies to generate images representing each anomaly. In the example 100, objects such as the fire extinguisher cabinet and the fire extinguisher itself may be identified and labeled.

A human may assist and validate the object identification and labeling in block 304. In some cases, a human may identify an object in an image using a cursor, pointing device, or other input device. In other cases, an artificial intelligence analysis may automatically identify and label objects in an image, which may be presented to a human user for validation.

A list of anomalies may be generated in block 306. The list may include many different types of anomalies that a classifier may be destined to identify. In many cases, a list of anomalies may be made using larger classifications, and within each classification, a more-focused list may be generated for as many ways as possible that the anomaly may occur.

In the example of a machining center used above, there may be a long list of various ways a blank may be mis-installed into a vice, as well as a long list of different ways that a cutting tool may be incorrect or unsuitable for operation. Each instance of these different ways may be identified as an anomaly.

The classification of anomalies into groups may be used in part for labelling and tagging anomalies. In many cases, an alarm processing system may have specific actions that may be triggered with specific anomalies.

For each anomaly in block 312, a representative image of that anomaly may be generated in block 314. The representative image may be generated using a text-based description of the anomaly. In many cases, the text-based description may describe modifications to the baseline image collected above.

The representative image may be presented to a human operator in block 316 for review and validation. If the representative image may not be OK in block 318, the human operator may have the ability to update the text-to-image query in block 320. Some systems may allow the human operator to edit the text-to-image query directly, while other systems may allow the human operator to provide input to the system, where the system may update or change the text-to-image query.

If the representative image may be OK in block 318, the system may generate multiple images of the anomaly in block 322. The number of images and the degree of change from one image to another may vary from one system to another.

Some anomalies may have many different variations, in such cases, an automated image generation system may create at least one image representing each variation. Some classification systems may also have increased accuracy when trained with more images. In such cases, the automated image generation system may generate many different images representing a particular anomaly. Because the system may be able to generate virtually unlimited numbers of images representing anomalies, a far more accurate and better trained classifier may be created than was possible using other methods.

After tagging the images with the anomaly description in block 324, the images may be used to train a classifier in block 326.

The classifier 326 may be deployed in block 328.

The system may receive an image in block 330, then process the image with the classifier in block 332. If the image is OK in block 334, the process may cycle back to block 330.

If the image is not OK in block 334, the anomaly may be identified in block 336 and an alarm corresponding to the anomaly may be raised in block 338.

The process may cycle back to block 330 and process additional images. The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

1. A system comprising:
at least one processor configured to perform a method comprising:
receiving an objective for a machine image classifier, said objective comprising a baseline state and an anomaly state;
identifying a set of baseline images representing said baseline state;
determining that for said first anomaly state, an insufficient number of representative images exist;
generating a plurality of conditions representing said anomaly state;
for each of said plurality of conditions, generating a plurality of images representing said conditions and classifying said plurality of images as said anomaly;
using said set of baseline images and said plurality of images to train said machine image classifier; and
deploying said machine image classifier to receive images and classify said images as said baseline state and said anomaly state.

2. The system of claim 1, said system further comprising a user interface, said user interface being configured to:
receive said objective from a user;
present at least one of said baseline images to said user;
receive a description of said anomaly state;
present at least one of said plurality of images representing one of said plurality of conditions for said anomaly state to said user; and
receiving approval of said at least one of said plurality of images representing one of said plurality of conditions for said anomaly from said user.

3. The system of claim 2, said method further comprising:
receiving an input comprising a target accuracy factor from said user interface.

4. The system of claim 3, said accuracy factor being used to determine a sufficient number of representative images for said first anomaly state.

5. The system of claim 2, said method further comprising:
using said at least one of said plurality of images for which approval has been given, generating an additional set of plurality of images that are variations of said at least one of said plurality of images.

5. The system of claim 1, said plurality of images representing conditions being generated automatically with no human interaction.

6. The system of claim 1, said plurality of conditions representing said anomaly state being generated automatically with no human interaction.

7. A system comprising:
a system with a user interface, said system configured to:
receive an objective from a user for a machine learning image classification system, said objective being to classify a target object in an image as being in a baseline state and an anomaly state;
display a first image to a user, said first image comprising said target object in said baseline state;
receive an input from said user describing said anomaly state;
identify said target object in said first image, and automatically generating at least one artificial image of said target object in said anomaly state;
displaying said artificial image to said user;
receiving confirmation from said user that said artificial image represents said anomaly state and automatically generating a minimum number of additional artificial images representing different versions of said anomaly state;
training a first image classifier using said first image and said minimum number of artificial images; and
deploying said image classifier.

8. The system of claim 7 further configured to:
receive a plurality of baseline images representing said baseline state and using said plurality of baseline images during said training.

9. The system of claim 8 further configured to:
receive descriptions for a plurality of situations that can be considered said anomaly state; and
for each of said descriptions, creating at least one artificial image representing at least one of said situations.

10. The system of claim 9, said descriptions comprising natural language descriptions of said situations.

11. The system of claim 10 further comprising:
automatically generating a plurality of variations of each of said situations;
using said plurality of variations to generate a second set of artificial images representing each of said situations; and
using said second set of artificial images as part of said training.
